(19) United States
(12) Patent Application Publication
(10) Pub. No.: US 2026/0163739 A1
(43) Pub. Date: Jun. 11, 2026

(54) TEMPORARY DIGITAL SHARED KEY ISSUANCE SYSTEM AND TEMPORARY DIGITAL KEY ISSUANCE METHOD

(71) Applicants: Hyundai Motor Company, Seoul (KR); Kia Corporation, Seoul (KR)

(72) Inventors: Kyoung Jun Noh, Hwaseong-Si, (KR); Kuk Jin, Hwaseong-Si (KR); Jeong Gi Yun, Hwaseong-Si (KR); Da Young Rho, Hwaseong-Si (KR)

(21) Appl. No.: 19/303,044

(22) Filed: Aug. 18, 2025

(30) Foreign Application Priority Data
Dec. 11, 2024 (KR) 10-2024-0183747

(51) Int. Cl. H04L 9/32; H04L 9/08

(52) U.S. Cl. CPC H04L 9/3228; H04L 9/085

(57) ABSTRACT

According to the present disclosure, a system may include a first computing device configured to execute a first digital key application. A pre-authorization indication for generating a temporary digital key for an authorized user may be transmitted from the first computing device via the first digital key application. The system may further include: a second computing device configured to execute a second digital key application associated with the authorized user; a server configured to receive the pre-authorization indication and to generate, based on authentication of the authorized user, the temporary digital key for use by the authorized user of the second computing device; and a vehicle controller configured to receive data transmitted from the server and control, based on the temporary digital key, a vehicle via the second digital key application.

### CROSS-REFERENCE TO RELATED APPLICATIONS

This application claims priority to Korean Patent Application No. 10-2024-0183747, filed in the Korean Intellectual Property Office on Dec. 11, 2024, which is hereby incorporated by reference for all purposes.

### TECHNICAL FIELD

The present disclosure relates to a temporary digital shared key issuance system and method.

### BACKGROUND

The digital key 2.0 system operates based on a smart phone of a vehicle owner. The vehicle owner may create a key sharing request through a digital key application for key sharing, and a key recipient (e.g., a would-be authorized user) may register and use the shared key after accepting the request.

However, such a system has limitations. For example, the owner must use a smart phone to issue a shared key, and the process requires active participation of the owner. This may create a challenge, for example, for an operator of a rental car or car sharing service to efficiently manage a large fleet of vehicles and users.

Therefore, in order to solve such a problem, there is a need for a simpler and more streamlined way of issuing a temporary digital key to an authorized user.

The matters described in this Background section are only for enhancement of understanding of the background of the disclosure, and should not be taken as acknowledgement that they correspond to prior art already known to those skilled in the art.

### SUMMARY

One objective of the present disclosure is to implement a system capable of issuing a digital key without a vehicle owner's intervention.

Technical issues to be addressed by the present disclosure are not limited to the technical issue mentioned above, and other technical issues that are not mentioned may be clearly understood by a person with an ordinary skill in the technical field to which the present disclosure pertains from the following descriptions.

According to one or more example embodiments of the present disclosure, a system may include: a first computing device configured to execute a first digital key application. A pre-authorization indication for generating a temporary digital key for an authorized user may be transmitted from the first computing device via the first digital key application. The system may further include: a second computing device configured to execute a second digital key application associated with the authorized user; a server configured to receive the pre-authorization indication and to generate, based on authentication of the authorized user, the temporary digital key for use by the authorized user of the second computing device; and a vehicle controller configured to receive data transmitted from the server and control, based on the temporary digital key, a vehicle via the second digital key application.

The first computing device may be further configured to transmit, via the first digital key application, a command to the server to store information on at least one of: an owner of the vehicle, the vehicle, the authorized user, authorization type of the authorized user, or a key sharing expiration time.

The second computing device may be further configured to transmit, to the server and via the second digital key application, a request to issue the temporary digital key.

The first computing device may be further configured to transmit, to the server, a request for at least one of: modifying a key sharing expiration time for authorization to share the temporary digital key with the authorized user; or withdraw the authorization.

The vehicle controller may be configured to control the vehicle by: authenticating the temporary digital key via a communication protocol. The communication protocol may include at least one of: near-field communication, Bluetooth Low Energy, or ultra-wideband.

The vehicle controller may be configured to control the vehicle by: controlling at least one of: locking a door of the vehicle, unlocking the door of the vehicle, starting the vehicle, opening a trunk of the vehicle, opening a window of the vehicle, or closing the window of the vehicle.

According to one or more example embodiments of the present disclosure, a method may include: registering, by a server and based on a pre-authorization indication transmitted from a first digital key application of a first computing device, an authorized user. The pre-authorization indication may indicate: a type of authorization to use a temporary digital key with a vehicle, and an expiration time for the authorization. The method may further include: receiving, by the server from a second computing device associated with the authorized user, a request for issuing the temporary digital key; issuing, by the server and based on the pre-authorization indication, the temporary digital key; and transmitting, by the server to the second computing device, the temporary digital key. The temporary digital key may be configured to, after authenticating with the vehicle via a communication protocol including at least one of near-field communication, Bluetooth Low Energy, or ultra-wideband, allow access to controlling at least one of: locking a door of the vehicle, unlocking the door of the vehicle, starting the vehicle, opening a trunk of the vehicle, opening a window of the vehicle, or closing the window of the vehicle.

The temporary digital key may be configured to allow the access based on a distance, as detected by an ultra-wideband transceiver of the vehicle, between the second computing device and the vehicle being within a threshold distance.

The temporary digital key may be configured to allow the access based on data of the temporary digital key being read by a sensor embedded in a door handle of the vehicle and authenticated by the vehicle.

The method may further include deactivating, by the server, the temporary digital key based on at least one of: a deactivation request from the first computing device or the expiration time.

The method may further include: receiving, by the server from the vehicle and based on the vehicle being started with the temporary digital key, an indication of which device, between the first computing device and the second computing device, is used to start the vehicle.

According to one or more example embodiments of the present disclosure, a server may include: a processor; and a memory storing at least one instruction that is configured, when executed by the processor communicating with the memory, to cause the server to: register, based on a pre-authorization indication transmitted from a first computing device, an authorized user. The pre-authorization indication may indicate a type of authorization to use a temporary digital key and an expiration time for the authorization. The at least one instruction may be configured, when executed by the processor communicating with the memory, to further cause the server to: receive, from a second computing device associated with the authorized user, a request for issuing the temporary digital key; issue, based on the pre-authorization indication, the temporary digital key; and transmit, to the second computing device, the temporary digital key.

The at least one instruction may be configured, when executed by the processor communicating with the memory, to further cause the server to deactivate the temporary digital key based on at least one of: a deactivation request from the first computing device or the expiration time.

The at least one instruction may be configured, when executed by the processor communicating with the memory, to further cause the server to: receive the pre-authorization indication from a digital key application being executed on the first computing device.

The at least one instruction may be configured, when executed by the processor communicating with the memory, to cause the server to receive the request by: receiving the request from a digital key application being executed on the second computing device.

### BRIEF DESCRIPTION OF DRAWINGS

FIG. 1 is a block diagram of a temporary digital shared key issuance system.

FIG. 2 is a flow diagram illustrating an example method an authorized user pre-registration and registration approval in a temporary digital shared key issuance system.

FIG. 3 is a flow diagram illustrating an example method an authorized user pre-registration procedure in a temporary digital shared key issuance system.

FIG. 4 is a flow diagram illustrating an example method of receiving and using a temporary key issued in a temporary digital shared key issuance system.

FIG. 5A and FIG. 5B are flow diagrams illustrating an example method of handling shared key expiration in a temporary digital shared key issuance system.

FIG. 6A and FIG. 6B are flow diagrams illustrating an example method of withdrawing key sharing authorization and deleting a key in a temporary digital shared key issuance system.

FIG. 7 is a flow diagram illustrating an example method of issuing a vehicle-in-use notification in a temporary digital shared key issuance system.

FIG. 8 shows an example computing system.

### DETAILED DESCRIPTION

Since the present disclosure may be modified in various ways, one or more example embodiments are illustrated and described in the drawings. However, this is not intended to limit the present disclosure to any specific example embodiment(s), and it should be understood that the present disclosure covers all modifications, equivalents, and alternatives included within the idea and scope of the present disclosure.

The suffixes “module” and “unit” used in the present specification are only used for name division between components, and should not be construed as being physiochemically divided or separated, or assuming that they may be divided or separated.

Terms including an ordinal number such as “first” and “second” may be used to describe various elements, but the elements are not limited by the terms. The terms are used only as a reference to distinguish one element from another element, and the sequential relationships between elements may be understood through the context of corresponding descriptions, not by the names.

The term “and/or” is used to cover all instances of any combination of the plurality of items for which it is intended. For example, “A and/or B” includes all three cases such as “A”, “B”, and “A and B”.

It will be understood that when an element is referred as being “connected” or “coupled” to another element, it may be directly connected or coupled to the other element, or intervening elements may be present.

The terminology used herein is for the purpose of describing one or more example embodiments only and is not intended to limit the present disclosure. Singular expressions may include plural expressions unless the context clearly indicates otherwise. In the present application, it should be understood that terms such as “include” or “have” are intended to designate the existence of the features, numbers, steps, operations, elements, parts, or combinations thereof described in the specification, and are not intended to preclude the possibility that one or more other features, numbers, steps, operations, elements, parts, or combinations thereof may exist or may be added.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, all terms used herein, including technical or scientific terms, have the same meanings as those generally understood by a person with an ordinary skill in the art to which the present disclosure pertains. It will be further understood that terms, such as those defined in commonly used dictionaries, should be interpreted as having a meaning that is consistent with their meaning in the context of the relevant art and will not be interpreted in an ideal or beyond the formal meaning unless expressly so defined herein.

In addition, a unit, a control unit, a control device, or a controller is a term widely used in the name of a device that controls a corresponding function and does not mean a generic function unit. For example, a device by these names may include a communication device that communicates with another controller or sensor to control a corresponding function, a computer-readable recording medium that stores an operating system or a logic command, input/output information, and the like, and one or more processors that perform determination, operation, determination, and the like necessary for controlling a corresponding function.

Meanwhile, the processor may include a semiconductor integrated circuit and/or electronic elements that perform at least one or more of comparison, determination, operation, and determination to achieve a programmed function. For example, the processor may be any one of a computer, a microprocessor, a CPU, an ASIC, and a circuitry (logic circuits), or a combination thereof.

The processor may be electrically connected to the memory, and the processor may retrieve and record data from the memory. The memory and the processor may be integrated or may be physically separated.

Hereinafter, one or more example embodiments of the present disclosure are described in detail with reference to the accompanying drawings.

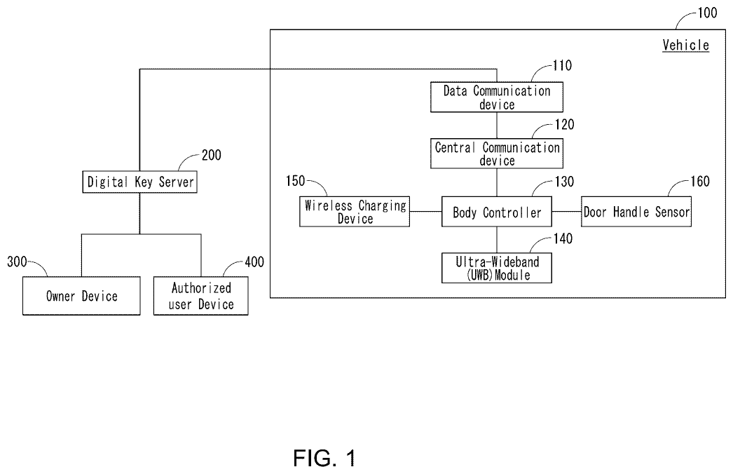

FIG. 1 is a block diagram of a temporary digital shared key issuance system.

Fewer or more elements may be included in the vehicle 100 and the temporary digital shared key issuance system than what is shown in FIG. 1.

Referring to FIG. 1, the digital key sharing system includes a vehicle owner device 300 (also referred to as a first (user) computing device), an authorized user device 400 (the authorized user device may be referred to as a second (user) device), a digital key server 200, and a vehicle 100. The vehicle 100 includes a data communication device 110, a central communication device 120, a body controller 130, a door handle sensor 160, a wireless charging device 150, and an ultra-wideband (UWB) module (also referred to as a UWB transceiver) 140.

Each of the owner device 300 and the authorized user device 400 may manage a digital key by a digital key application installed therein.

The digital key server 200 may serve as a central hub for digital key issuance and authentication. It may store and manage owner and authorized user account information, process digital key generation and authorization setting data, synchronize vehicle information and usage status in real time, and connect to owner terminals (e.g., the owner device 300), authorized user terminals (e.g., the authorized user device 400), and a vehicle through a 5G or Long-Term Evolution (LTE) network. In addition, in terms of security, it is possible to ensure safe transmission and reception of data through Advanced Encryption Standard 256 (AES-256) encryption and TLS communication.

The data communication device 110 is a central control device for digital key authentication and control command processing in a vehicle. The data communication device 110 may also be referred to as a vehicle control system or a vehicle controller. The data communication device 110 may communicate with the digital key server 200 through 5G/LTE. Digital key data may be transmitted to the central communication device 120 through Ethernet communication.

The data communication device 110 may execute commands for controlling vehicle functions such as door locking, door unlocking, allowing starting the vehicle, trunk opening, window opening and closing, etc.

The central communication device 120 is a Central Communication Unit, and includes a control device that manages various communications in the vehicle and supports connection in communication with an outside apparatus. In the present disclosure in regard to the digital key system, it may serve as an interface between an internal communication network of the vehicle and an external communication network and may serve to enhance connectivity of the vehicle.

The central communication device 120 may exchange data with other control units (e.g., the data communication device 110 and the body controller 130) through a communication network such as controller area network (CAN), local interconnect network (LIN), Ethernet, or the like in the vehicle. It is possible to transmit the digital key authentication result through an internal network or execute commands such as vehicle locking/unlocking and starting.

The central communication device 120 may process the digital key data transmitted from the data communication device 110 and transmit the processed digital key data to the body controller 130. In addition, it is connected to the internal network of the vehicle through CAN communication. In addition, an over-the-air (OTA) update may be supported, and a new function or a security patch may be applied by wirelessly updating software of the digital key system.

The body controller (also referred to as a body control module or a body computer) 130 may be a central device that controls various functions and electronic accessories in a vehicle's body, such as power windows, power mirrors, air conditioning, immobilizer system, central locking, opening and closing a trunk or power gate, seat warmers, seat coolers, seat adjusters, etc. In the present disclosure, the body controller 130 may receive digital key authentication data from the data communication device 110 and the central communication device 120 and may perform a vehicle external interface and control function such as vehicle locking/unlocking, window control, trunk opening, etc. Based on a digital key (e.g., a shared digital key) being authenticated, the body controller 130 may allow the authorized user computing device 400 to control one or more of the functions and electronic accessories of the vehicle as described herein. The body controller 130 may allow this, for example, if the authorized user computing device 400 is adjacent to the vehicle 100 (e.g., located within a threshold distance away from the vehicle 100, for example, as detected by the UWB module 140).

The body controller 130 may be connected to the door handle sensor 160 to perform near-field communication (NFC)-based locking/unlocking.

The body controller 130 may exchange data with other control devices through an internal network such as CAN and LIN in the vehicle.

The UWB module 140 includes UWB and Bluetooth Low Energy (BLE). UWB is an abbreviation of Ultra-Wideband (Super Wide Band) and includes a wireless technology that provides high-precision location recognition and communication over a short distance. UWB is integrated with a digital key system and is used as a high-precision location-based authentication technology for vehicle access and start-up authentication, and unlike NFC or BLE, UWB may measure distance and direction, thereby supporting safer and more precise authentication.

The wireless charging device 150 is a component related to an in-vehicle wireless charging technology, and in the present disclosure, the wireless charging device 150 may operate together with an NFC and the digital key system and may perform a function related to digital key authentication when the first or second device storing a digital (shared) key is placed thereon.

The wireless charging device 150 is a wireless charging system that supports NFC-based authentication and may support unlocking and starting of the vehicle together with digital key authentication through NFC technology. The user may complete the authentication process with the vehicle by placing a digital key, such as a smartphone, which is one example of the first or second device storing the digital key, or an NFC card, on the area of the wireless charging device 150.

The wireless charging device 150 provides wireless charging for the smartphone inside the vehicle to support the user to continuously use the smartphone. Since authentication and digital key issuance operation using NFC are performed on the smartphone, a wireless charging for maintaining the battery state may be essential.

The user may simultaneously perform digital key authentication and wireless charging by simply placing the smartphone on the charging pad of the wireless charging device 150. This may contribute to preventing the battery of the smartphone from being fully discharged while using the digital key.

The door handle sensor 160 may include a sensor embedded in a door handle of the vehicle. In the present disclosure, the door handle sensor 160 may be linked with the digital key system to perform an operation for allowing vehicle access and locking/unlocking a door. In particular, it may be integrated with NFC to serve to control the door when the smartphone or the NFC key is brought close thereto.

The door handle sensor 160 may detect whether the user has approached the vehicle door using a proximity sensor and an NFC reader embedded in the vehicle door handle. When a user carrying a smartphone or an NFC key approaches near a door handle, the door handle sensor 160 may recognize this and start an authentication procedure.

The door handle sensor 160 may change the lock state of the vehicle door according to the digital key authentication result, and when the authentication succeeds, the vehicle door may be unlocked, the user may access the vehicle, and when the authentication fails, the vehicle may maintain the lock state and transmit a security notification.

When unauthorized access is performed, the door handle sensor 160 may analyze the NFC data to record an authentication failure state and transmit a warning to the digital key server 200 or the user smartphone. This strengthens vehicle security and can detect unauthorized access in real time.

The door handle sensor 160 may inform the user of a lock/unlock state of the vehicle door through a light-emitting diode (LED) display or a sound.

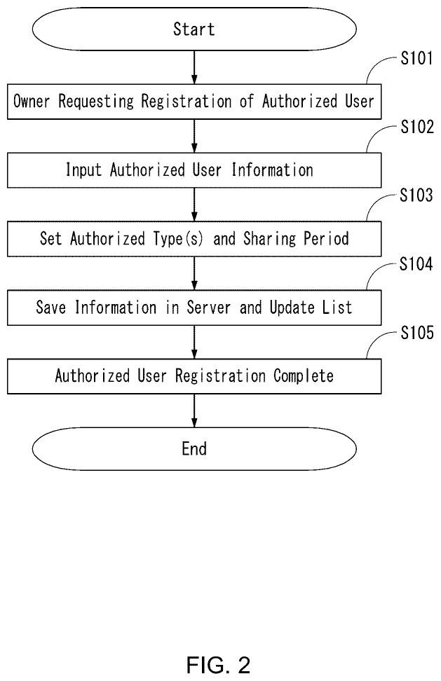

FIG. 2 is a flow diagram of an example method of an authorized user pre-registration and registration approval in a temporary digital shared key issuance system.

In the process S101 in which the owner (e.g., the owner computing device 300) requests registration of the authorized user (also referred to as the key recipient), the vehicle owner may log-in to the digital key application and select a “authorized user registration” menu. The owner may then select a vehicle to be registered on a vehicle selection screen. A vehicle list may include vehicle information registered in advance by an account of an owner.

In the authorized user information inputting process S102, the owner may input a digital key application account information (ID) of the authorized user. The authorized user may generate the digital key application account in advance (e.g., before the owner requests registration of the authorized user), and the corresponding ID may be input by the owner. After accurately entering the information of the authorized user, the process may proceed to the next step.

In authorization (e.g., permission) type and authorization period setting process S103, the owner may set the type(s) of authorization (e.g., permission) and its time period (e.g., expiration time) to be granted to the authorized user. The authorization type setting may include selecting an operation range (e.g., a distance that the authorized user may travel from an origin location, etc.) that is permitted to the authorized user. For example, the authorization type setting may be set to allow both vehicle entry and vehicle start, allow vehicle entry only, allow vehicle entry and vehicle start-up until a specific time, etc. The time period setting (e.g., expiration time setting) may include setting a time period during which the authorization (e.g., permission) is valid.

In information storing in server and list updating process S104, when the owner completes the setting, the input information may be stored in the digital key server. The digital key server may update the list including the owner and authorized user information and record the authorization (e.g., permission) and its period in relation to the vehicle.

In the authorized user registration completion process S105, after the registration is completed, the digital key server may transmit a registration completion notification to the authorized user. The authorized user may complete a preparation for vehicle access and use through the digital key application, and the owner may manage or, if necessary, modify and delete the authorization (e.g., permission) through an authorized user list registered in the server.

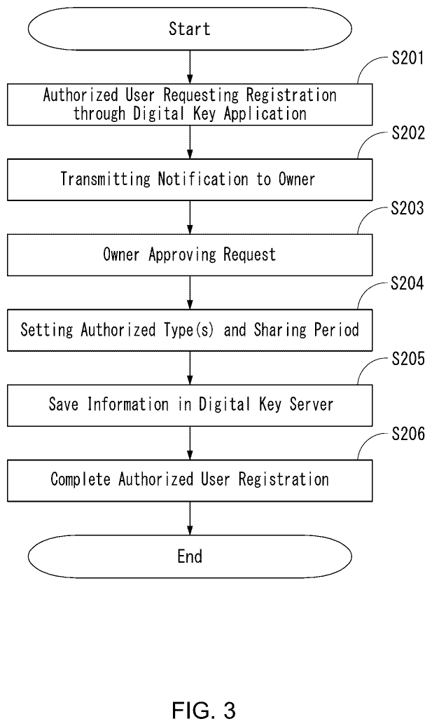

FIG. 3 is a flow diagram of an example method of an authorized user pre-registration procedure in a temporary digital shared key issuance system.

In the process S201 of the authorized user (e.g., the authorized user computing device 400) requesting registration through the digital key application, the authorized user may execute the digital key application in his or her smartphone and select a “request to register authorized user” menu. The authorized user may enter his or her contact number and the vehicle number for the requesting the registration. The input information may be transmitted to the digital key server to be transmitted to the owner as a notification.

In the process S202 of transmitting the notification to the owner, the digital key server may transmit the request information of the authorized user to the owner and transmit the notification to the owner. The owner may check the authorized user registration request through his or her digital key application.

In the process S203 of the owner approving the request, the owner may read the notification message and then access the digital key application to review the request. The owner may check information of the authorized user in connection to the vehicle on a request screen, and may approve or reject the request if necessary.

In the process S204 of setting authorization (e.g., permission) type(s) and its authorization time period (e.g., authorization expiration time), if the owner approves the request, the owner may set the authorization (e.g., whether access or start is possible) to grant to the authorized user and the time period.

In the process S205 of storing the information in the digital key server, when the owner completes the setting, the corresponding information may be stored in the digital key server. The stored information may include information such as contact information of the authorized user, authorization (e.g., permission), authorization period, and the vehicle number.

In the process S206 of completing the registration of the authorized user, the digital key server may transmit a registration completion message to the authorized user, and the authorized user may check a registered state through the digital key application. After the registration is completed, the authorized user may be in a state in which the authorized user may request and use a digital key for vehicle access and use.

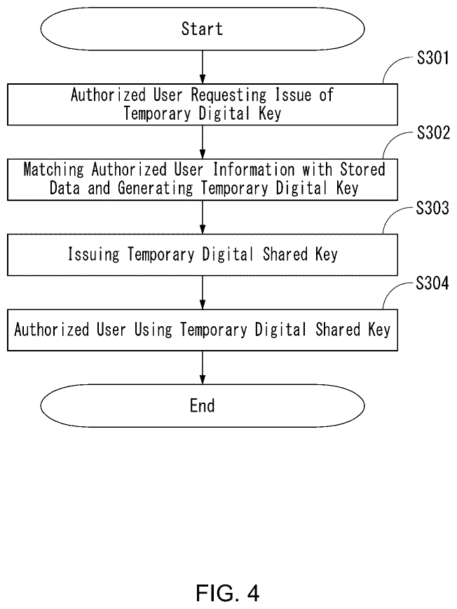

FIG. 4 is a flow diagram of an example method of receiving and using a temporary key issued in a temporary digital shared key issuance system.

In the process S301 of requesting issuance of the temporary shared key, the authorized user (e.g., the authorized user computing device 400) may request a temporary digital key authorized by the owner through a digital key application installed on the authorized user's smartphone. With the request, account information and authorization (e.g., permission) information (e.g., time period, vehicle model, vehicle identity, etc.) of the authorized user may be transmitted to the digital key server. This process may be performed in real time through 5G/LTE network.

In the process S302 of matching authorized user information and generating a key, the digital key server may receive the authorized user's request and check owner's and authorized user's information stored in the server. If the requested vehicle and authorization (e.g., permission) information match information pre-registered in the server, the server may authenticate the authorized user and generate a temporary digital key. When the matching information is inaccurate or the authorization (e.g., permission) has expired, a key may not be issued.

In the process S303 of issuing the temporary shared key, the digital key server may transmit the generated temporary digital key (e.g., the temporary shared key) to the authorized user's smartphone. The authorized user may check the key issued through the digital key application and complete a preparation for vehicle access and use.

In the process S304 of using the issued temporary key by the authorized user, the authorized user may access and use the vehicle by using the digital key stored in the smartphone. The body controller 130 may authenticate the digital key of the authorized user through various communication technologies such as NFC, BLE, UWB, etc.

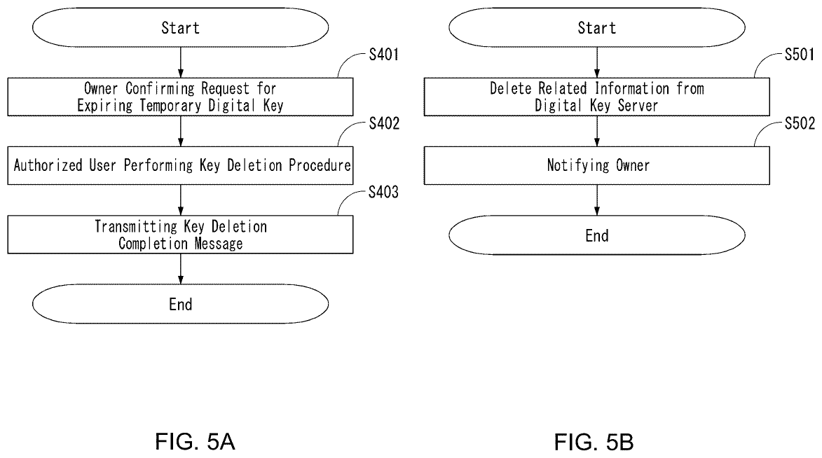

FIG. 5A and FIG. 5B are flow diagrams of an example method of handling shared key expiration in a temporary digital shared key issuance system.

FIG. 5A illustrates an example case in which an authorized user, whose sharing period has expired, has and uses a key already issued.

In the process S401 of the owner (e.g., the owner computing device 300) confirming the request for expiration of the shared key (e.g., the owner requesting to retire a previously issued shared key), if the period of use of the shared key has expired, the digital key server may confirm the expiration of the period, and may start a key deletion procedure for the corresponding authorized user. The server may transmit a key delete command message to the authorized user.

In the process S402 of the authorized user (e.g., the authorized user computing device 400) performing the key deletion procedure, the authorized user may receive the key deletion command through the smartphone (e.g., the authorized user device 400) and the authorization (e.g., permission) to use the key in the vehicle may be removed. Thereafter, the authorized user may no longer be able to access (e.g., gain entry to) or start the vehicle.

In the process S403 of transmitting the key deletion completion message, when the key deletion is completed, the digital key server may transmit the deletion completion message to the owner. Also, the data of the corresponding authorized user may be deleted from the owner and authorized user connection list information (e.g., a database storing one or more associations between vehicle owners (e.g., permission granters) and their corresponding authorized users) of the server to ensure the previously authorized user no longer has vehicle access authorization (e.g., permission).

FIG. 5B illustrates an example case where a shared key has not been issued.

In the process S501 of deleting the connection information from the digital key server, the digital key server may confirm that the shared key has not been issued, and may delete the corresponding authorized user information. Related data may be removed from the owner and authorized user connection list on the server.

In the process S502 of owner notification, the digital key server may notify the owner that the key use authorization expiry has been completed by transmitting a message informing that “key sharing authorization has been removed” to the owner.

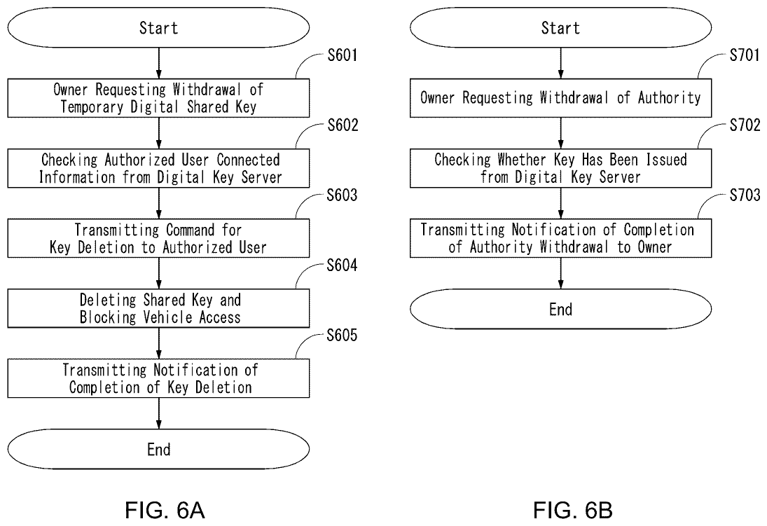

FIG. 6A and FIG. 6B are flow diagrams of an example method of withdrawing key sharing authorization and deleting a key in a temporary digital shared key issuance system.

Referring to FIG. 6A, a shared key may be issued to an authorized user.

In the process S601 of the owner (e.g., the owner computing device 300) requesting a withdrawal (e.g., termination, cancelation, rescission, etc.) of the shared key, the owner computing device 300 may withdraw (e.g., terminate, cancel, rescind, etc.) the authorization of the authorized user through the digital key application and request the deletion of the corresponding shared key from the digital key server. Alternatively, the owner computing device 300 may request, to the digital key server 200, modification of previously granted authorization (e.g., modifying the type and/or time period of the authorization). Based on the request, the digital key server 200 may modify the type and/or time period of the authorization.

In the process S602 of the digital key server confirming the information in connection to the authorized user from, the digital key server may confirm the information of the authorized user requested by the owner and inquire a state of the shared key. It can be confirmed that a key has already been issued to the authorized user and is in use.

In the process S603 of transmitting the delete key command to the authorized user, the digital key server may transmit a vehicle key delete command message to the authorized user. After receiving the key delete command, the authorized user may have to deactivate or delete the corresponding key from his or her smartphone.

In the process S604 of deleting the shared key and blocking access to the vehicle, communication between the vehicle (e.g., the vehicle 100) and the authorized user's smartphone (e.g., the authorized user device 400) may be terminated after the authorized user performs the key deletion. Subsequently, the authorized user may no longer be able to access (e.g., open) or start the vehicle.

In the process S605 of transmitting the complete key deletion notification, the digital key server may notify the owner that the deletion of the shared key has been completed. Also, information related to the authorized user may be deleted from the connection list on the server to ensure that the corresponding key is no longer valid.

FIG. 6B illustrates an example case where a shared key has not been issued to the corresponding authorized user.

In the process S701 of the owner requesting withdrawal of authorization, the owner (e.g., the owner computing device 300) may request the digital key server to withdraw the connection with a specific authorized user and its authorization.

In the process S702 of confirming whether the digital key server has issued the key, the digital key server may confirm that the key has not been issued to the requested authorized user.

In the process S703 of transmitting the withdrawal completion notification to the owner, the digital key server transmits a message informing “the corresponding key sharing authorization has been withdrawn” to the owner, while the corresponding information can be deleted from the authorized user list of the server so that the authorized user can no longer have the authorization.

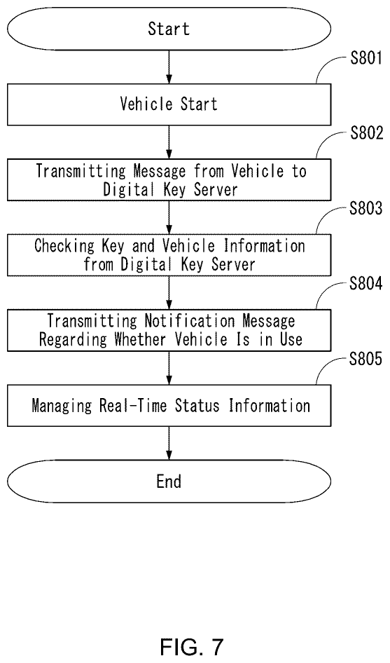

FIG. 7 is a flow diagram of an example method of issuing a vehicle-in-use notification in a temporary digital shared key issuance system.

In the process S801 of starting the vehicle engine, the vehicle owner or the authorized user may start the vehicle engine using the digital key. Vehicle state information may be transmitted to the server at the same time as the vehicle starts.

In the process S802 of transmitting a message from the vehicle to the digital key server, the vehicle control system may transmit a vehicle start state and vehicle key information to the digital key server. The message may include data regarding a current state of the vehicle (whether the engine is starting, key information, etc.), detailed information on which key is used (shared key or owner's key), a user, an authorization and a use period of the used key, etc.

In the process S803 of confirming the vehicle and the key information on the digital key server, the digital key server may analyze the key information related to the vehicle state based on a received message. If the vehicle key is used by the authorized user according to the corresponding message, the server may prepare a notification to the owner or the authorized user.

In the process S804 of transmitting the notification message related to whether the vehicle is in use, if the authorized user uses the vehicle, the server may notify the owner of the vehicle use history. For example, a message “vehicle X in use” may be transmitted to the owner smartphone. If the owner uses the vehicle, the server may inform the authorized user of the vehicle use status. When the vehicle owner information is included in the message, the server may transmit the notification of “XX vehicle in use” to the authorized user in the same format.

In the process S805 of managing real-time state information, the digital key server may store the vehicle state and use information in real time, and may provide an additional notification (e.g., an abnormal vehicle state, a warning, etc.) to the user when necessary.

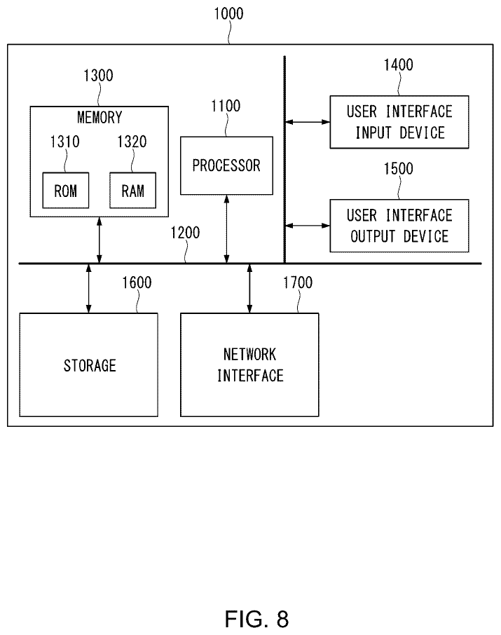

FIG. 8 shows an example computing system (e.g., a computing device of a vehicle or any other apparatus). One or more controllers, processors, etc. described herein may be implemented by the computing system or may be implemented in the computing system. For example, one or more of the vehicle 100, the data communication device 110, the central communication device 120, the body controller 130, the UWB module 140, the wireless charging device 150, the door handle sensor, 160, the digital key server 200, the owner device 300, and the authorized user device 400, as shown in FIG. 1, may be implemented with one or more instances of a computing system (also referred to as a computing device) 1000.

A computing system (also referred to as a computing device) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, LTE, 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A system for issuing a digital shared key may include a first device in which a first digital key application is installed, a second device in which a second digital key application is installed, a server configured to generate a digital key, and a vehicle control system configured to receive data transmitted from the server and control a vehicle, wherein the server is configured to generate the digital key based on an authenticated sharer information.

The first device may be configured to transmit through the first digital key application a command to the server to store information of an owner of the vehicle, vehicle information and/or information of a sharer, authority of the sharer, and a use period of the sharer.

The second device may be configured to transmit a request for issuing the digital key to the server through the second digital key application.

The first device may be configured to transmit to the server a request for changing or withdrawing an authority and/or a use period of a sharer through the second digital key application.

The vehicle control system may be further configured to authenticate the digital key through at least one communication protocol of Near Field Communication (NFC), Bluetooth Low Energy (BLE), or Ultra-Wideband (UWB), and control the vehicle.

The vehicle control system may be further configured to control at least one of locking or unlocking a door of the vehicle, allowing starting the vehicle, opening a trunk of the vehicle, or opening and closing a window of the vehicle.

A method for issuing a digital key may include registering, by a server, a sharer based on data transmitted from a first device through a first digital key application and setting information, authority, and a use period of the sharer, transmitting, by a second device, a request for issuing a digital key to the server, issuing, by the server, the digital key based on the information, the authority, and the use period, transmitting, by the server, the digital key to the second device, authenticating, by a vehicle control system, the digital key through one communication protocol of Near Field Communication (NFC), Bluetooth Low Energy (BLE), or Ultra-Wideband (UWB), and executing, by the vehicle control system, at least one control of locking or unlocking a door of the vehicle, allowing starting the vehicle, opening a trunk of the vehicle, or opening and closing a window of the vehicle based on a result of the authenticating.

The executing the at least one control may be performed only when the second device is detected by use of a UWB module to be adjacent to or in the vehicle.

The executing the at least one control may include receiving data of the digital key through a door handle sensor embedded in a door handle of the vehicle and checking the result of the authenticating through a data communication device.

The method may further include deactivating, by the server, the digital key according to a request from the first device or based on the use period expiring.

The method may further include providing, by the vehicle control system, information on whether the vehicle is used to the first device or the second device as a notification based on the vehicle being started with the digital key.

There is provided a server comprising a non-transitory computer-readable memory storing computer-readable instructions, and one or more processors configured to execute the computer-readable instructions, wherein the one or more processors is configured to cause, by executing the computer-readable instructions, the server to register a sharer based on data transmitted from a first device, set information, authority, and a use period of the sharer, receive a request for issuing a digital key from a second device, issue the digital key based on the information, the authority, and the use period, and transmit the digital key to the second device.

The one or more processors may be further configured to cause, by executing the computer-readable instructions, the server to deactivate the digital key according to a request from the first device or based on the use period expiring.

The first device may include a first digital key application installed thereon for use of an owner of the vehicle, and the one or more processors may be further configured to cause the server to receive the data transmitted from the first device by the first digital key application.

The second device may include a second digital key application installed thereon for use of the sharer, and the one or more processors may be further configured to cause the server to receive the request for issuing the digital key from the second device by the second digital key application.

A temporary digital key can be issued to a sharer without a smartphone or physical intervention by a vehicle owner, thereby enabling efficient vehicle access and use even in an emergency situation or when the owner is absent.

Technical effects achievable from the present disclosure are not limited to the effects mentioned above, and other effects not mentioned will be clearly understood by a person with an ordinary skill in the technical field from the following description.

It is apparent to a person with an ordinary skill in the art that the present disclosure may be embodied in other forms without departing from the idea and essential features of the present disclosure. Accordingly, the above detailed description should not be construed as limiting in any respect and should be considered as illustrative. The scope of the present disclosure should be determined by reasonable interpretation of the appended claims, and all changes within the equivalent scope of the present disclosure are included in the scope of the present disclosure.

Examples of computer-readable recording medium include a ROM, a RAM, a CD-ROM, a magnetic tape, a floppy disk, an optical data storage device, etc. and also include a device implemented in the form of a carrier wave (e.g., transmission through the Internet).

The computer-readable recording medium may be distributed to computer systems connected through a network, and computer-readable codes may be stored and executed in a distributed manner. In addition, functional programs, codes, and code segments for implementing the above-described method may be easily inferred by programmers in the art to which the embodiment pertains.

What is claimed is:

1. A system comprising:
a first computing device configured to execute a first digital key application, wherein a pre-authorization indication for generating a temporary digital key for an authorized user is transmitted from the first computing device via the first digital key application;
a second computing device configured to execute a second digital key application associated with the authorized user;
a server configured to receive the pre-authorization indication and to generate, based on authentication of the authorized user, the temporary digital key for use by the authorized user of the second computing device; and
a vehicle controller configured to receive data transmitted from the server and control, based on the temporary digital key, a vehicle via the second digital key application.

2. The system of claim 1, wherein the first computing device is further configured to transmit, via the first digital key application, a command to the server to store information on at least one of:
an owner of the vehicle,
the vehicle,
the authorized user,
authorization type of the authorized user, or
a key sharing expiration time.

3. The system of claim 1, wherein the second computing device is further configured to transmit, to the server and via the second digital key application, a request to issue the temporary digital key.

4. The system of claim 1, wherein the first computing device is further configured to transmit, to the server, a request for at least one of:
modifying a key sharing expiration time for authorization to share the temporary digital key with the authorized user; or
withdraw the authorization.

5. The system of claim 1, wherein the vehicle controller is configured to control the vehicle by:
authenticating the temporary digital key via a communication protocol, wherein the communication protocol comprises at least one of: near-field communication, Bluetooth Low Energy, or ultra-wideband.

6. The system of claim 1, wherein the vehicle controller is configured to control the vehicle by:
controlling at least one of: locking a door of the vehicle, unlocking the door of the vehicle, starting the vehicle, opening a trunk of the vehicle, opening a window of the vehicle, or closing the window of the vehicle.

7. A method comprising:
registering, by a server and based on a pre-authorization indication transmitted from a first digital key application of a first computing device, an authorized user, wherein the pre-authorization indication indicates:
a type of authorization to use a temporary digital key with a vehicle, and
an expiration time for the authorization;
receiving, by the server from a second computing device associated with the authorized user, a request for issuing the temporary digital key;
issuing, by the server and based on the pre-authorization indication, the temporary digital key; and
transmitting, by the server to the second computing device, the temporary digital key, wherein the temporary digital key is configured to, after authenticating with the vehicle via a communication protocol comprising at least one of near-field communication, Bluetooth Low Energy, or ultra-wideband, allow access to controlling at least one of: locking a door of the vehicle, unlocking the door of the vehicle, starting the vehicle, opening a trunk of the vehicle, opening a window of the vehicle, or closing the window of the vehicle.

8. The method of claim 7, wherein the temporary digital key is configured to allow the access based on a distance, as detected by an ultra-wideband transceiver of the vehicle, between the second computing device and the vehicle being within a threshold distance.

9. The method of claim 7, wherein the temporary digital key is configured to allow the access based on data of the temporary digital key being read by a sensor embedded in a door handle of the vehicle and authenticated by the vehicle.

10. The method of claim 7, further comprises deactivating, by the server, the temporary digital key based on at least one of: a deactivation request from the first computing device or the expiration time.

11. The method of claim 7, further comprising:
receiving, by the server from the vehicle and based on the vehicle being started with the temporary digital key, an indication of which device, between the first computing device and the second computing device, is used to start the vehicle.

12. A server comprising:
a processor; and
a memory storing at least one instruction that is configured, when executed by the processor communicating with the memory, to cause the server to:
register, based on a pre-authorization indication transmitted from a first computing device, an authorized user, wherein the pre-authorization indication indicates a type of authorization to use a temporary digital key and an expiration time for the authorization;
receive, from a second computing device associated with the authorized user, a request for issuing the temporary digital key;
issue, based on the pre-authorization indication, the temporary digital key; and
transmit, to the second computing device, the temporary digital key.

13. The server of claim 12, wherein the at least one instruction is configured, when executed by the processor communicating with the memory, to further cause the server to deactivate the temporary digital key based on at least one of: a deactivation request from the first computing device or the expiration time.

14. The server of claim 12, wherein the at least one instruction is configured, when executed by the processor communicating with the memory, to further cause the server to:
receive the pre-authorization indication from a digital key application being executed on the first computing device.

15. The server of claim 12, wherein the at least one instruction is configured, when executed by the processor communicating with the memory, to cause the server to receive the request by:
receiving the request from a digital key application being executed on the second computing device.
